(19) United States
(12) Patent Application Publication
(10) Pub. No.: US 2008/0063469 A1
(43) Pub. Date: Mar. 13, 2008

(54) Interlocking Separable Joint

(76) Inventors: Errol Drew, Northampton (GB); Philip Karl, Providence, RI (US)

Correspondence Address: FOLEY & LARDNER LLP, 111 HUNTINGTON AVENUE, 26TH FLOOR, BOSTON, MA, 02199-7610, US

(21) Appl. No.: 10/591,729

(22) PCT Filed: Mar. 1, 2005
(86) PCT No.: PCT/US05/06771

§ 371 Date: Sep. 12, 2007

Related U.S. Application Data
(60) Provisional application No. 60/549,408, filed on Mar. 1, 2004.

(51) Int. Cl. F16D 1/02

(52) U.S. Cl. 403/345

(57) ABSTRACT

Ion mobility spectrometer. The spectrometer includes an enclosure for receiving a sample therewithin and an electron beam window admits an electron beam into the enclosure to ionize the sample in an ionization region. A shutter grid is spaced apart from the ionization region and means are provided for sample ion preconcentration upstream of the shutter grid. The ion preconcentration is effective to reduce space charge resulting in a lowered threshold detection level.

### REFERENCE TO RELATED APPLICATIONS

The present application claims priority to and the benefit of U.S. Provisional Application No. 60/549,408, filed Mar. 1, 2004 and entitled A Single Main Beam Bicycle and A Separable Joint, the content of which is hereby incorporated by reference.

### TECHNICAL FIELD

The invention relates generally to separable joints and more particularly to a joint capable of joining ends of two beams.

### BACKGROUND

In the design and assembly of structures, joints are typically used to secure beams to one another. There is often a desire to join beams axially so as to form a longer, overall beam. Several methods for joining beams have been used, such as the use of plates on each side of the ends of the beam, or locating a rod or dowel axially within the ends of the beams.

However, beam joints frequently require significant amounts of additional material, increasing the weight or dimensions of the beam joint. Beam joints requiring assembly of multiple, separate components for aligning the beams may be difficult to assemble. Examples include beam joints using plates with numerous bolts. Such conventional beam joints may also be difficult to disassemble.

### SUMMARY

The present invention seeks to address various needs in the art to provide a beam joint that can be readily assembled and disassembled, while providing a rigid joint. Various embodiments of the present invention are also directed to avoid a need for substantial amounts of additional, bulky parts, such as side plates bolted along the sides of the beams being joined. In some applications, the present invention can be located within the outer contours of the beams being joined, allowing for a consistent external diameter or cross-sectional dimensions.

In one illustrative embodiment, a beam joint is provided having a first portion with a first protruding element and a second portion having a second protruding element configured to mate with the first protruding element. A transverse stabilizer is provided on the first portion, with a transverse stabilizer receptor for receiving the transverse stabilizer, provided on the second portion. The first protruding element can have a first beveled face and the second protruding element can have a second beveled face, the first beveled face is configured for mating with the second beveled face. Also, the beveled faces can extend across a full cross-section of their respective portion. A fastener may also be provided transversally in the first and second portion to retain the portions in a mating configuration.

In one embodiment, the beam joint is used in a main beam of a bicycle, although the invention is not so limited.

### BRIEF DESCRIPTION OF THE DRAWINGS

The invention will be apparent from the description herein and the accompanying drawings, in which like reference characters refer to the same parts throughout the different views.

FIG. 1 is an exploded view of a separable joint according to an embodiment of the invention;

FIG. 2 is a reverse view of a second portion of the separable joint of FIG. 2;

FIG. 3 is an exploded view of a separable joint according to an embodiment of the invention;

FIG. 4 is a reverse view of a second portion of the separable joint of FIG. 4;

FIG. 5 is an exploded view of a separable joint according to an embodiment of the invention;

FIG. 6 is a reverse view of a second portion of the separable joint of FIG. 6; and

FIG. 7 is a side view of a separable joint used in a bicycle according to an embodiment of the invention.

### DETAILED DESCRIPTION

The present invention provides a separable joint for use in joining beams. As used herein, the term “beam” is used to represent a wide variety of structural members. Examples include, but are not limited to, I-beams, tubes, poles, shafts, T-beams and rods. Applications can also vary widely and can include, but are not limited to, bicycles, structural members for buildings, bridges, towers, tents or any other application involving the coupling of ends of two members to form a longer overall member.

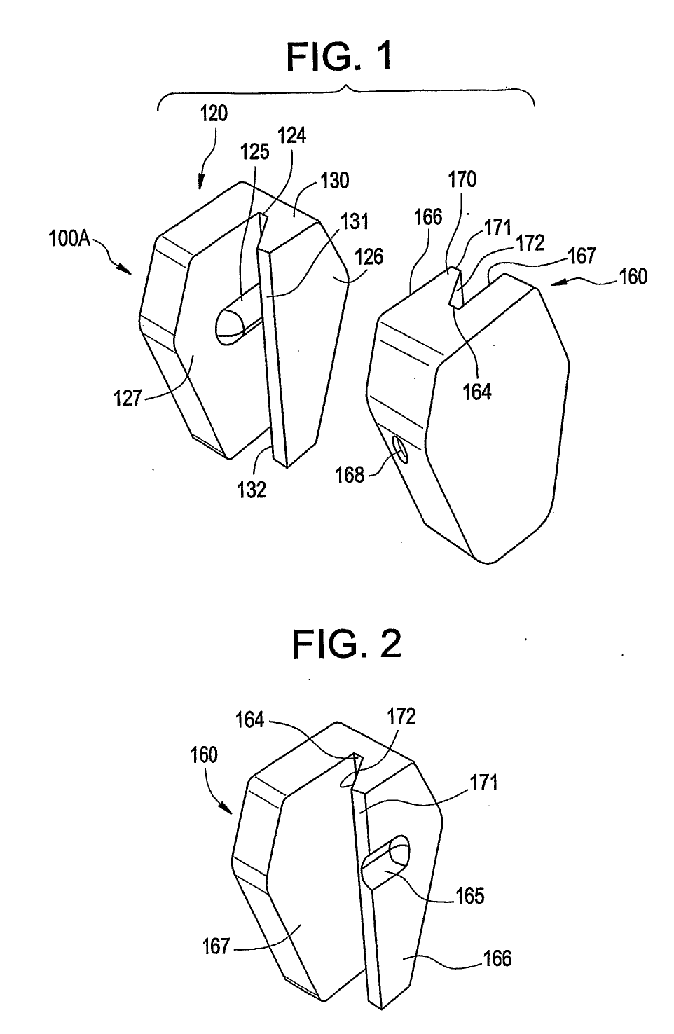

Examples of separable joints according to illustrative embodiments of the invention are provided in FIGS. 1-6. With reference to FIG. 1, a separable joint 100A is illustrated in exploded form. By way of example, the separable joint 100A is implemented in a six-sided beam or post. According to the illustrative embodiment of FIGS. 1 and 2, the separable joint 100A is provided with a first portion 120 that is separable from a second portion 160. FIG. 2 provides a reverse view of the second portion 160. Each of the first and second portions 120, 160 has a protruding element that mates, interacts, or interlocks, with the protruding element of the other portion. The first portion 120 has a first protruding element 130, and the second portion 160 has a second protruding element 170.

The first and second protruding elements 130, 160 are provided with first and second end faces 126, 166, first and second bevel faces 132, 172 and optionally with first and second protruding element tip faces 131, 171. As illustrated by way of example, the first and second bevel faces 132, 172 may extend across a full cross section of their respective first and second portions 120, 160. Optional first and second side faces 124, 164 extend to first and second inner faces 127, 167. The protruding element tip faces 131, 171 and/or the first and second inner faces 127, 167 may optionally be of a very small width or be omitted altogether.

The first inner face 127 is provided with a transverse stabilizer 125 and the second end face 166 is provided with a transverse stabilizer receptor 165. The location of the transverse stabilizer 125 and transverse stabilizer receptor 165 are illustrated by way of example only, as they can be located in a wide variety of positions in order to maintain the transverse alignment of the beam joint. An optional fastener hole 168 is provided in the second portion 160 in which to locate a fastener that can extend into or through the first portion 120 to further secure the first portion 120 to the second portion 160. The fastener hole 168 may also be located in a wide variety of positions. If the fastener extends into the first portion 120, the hole (not shown) in the first portion 120 to receive the fastener may be configured to retain the fastener in the hole, coupled to the first portion 120. In one example, threads are provided in a hole in the first portion 120 such that a bolt provided through the fastener hole 168 in the second portion 160 may be secured to the first portion 120 by the use of the threads.

In another example, a quick-release cam assembly can be used on an end of a rod. For example, one end of the rod could have a ball or other enlarged cross-section that can be secured to a suitable structure at or near one end of the fastener hole 168. The opposing end of the rod could have a cam with a handle to enable the cam to be rotated to axially tighten against the ends of the fastener hole 168, thereby securing the first portion 130 to the second portion 160. Other examples of structures to secure the first portion 130 to the second portion 160 can include an outer sleeve or clamp assembly.

In operation, the separable joint 100A is configured to receive tensile, compression and shear loads, individually and in combination. The first portion 120 and second portion 160 are joined by a lateral or transverse motion to bring the first and second bevel faces 132, 172 into contact with each other and locate the transverse stabilizer 125 in the transverse stabilizer receptor 165. The first and second bevel faces 132, 172 contact each other to inhibit separation of the first and second inner faces 127, 167 from the first and second end faces 126, 166. By inhibiting separation of the first inner face 127 from the second end face 166, the transverse stabilizer 125 remains coupled to the transverse stabilizer receptor 165. The transverse stabilizer 125 and the transverse stabilizer receptor 165 maintain transverse alignment of the first and second portions 120, 160 by preventing the first and second portions 120, 160 from sliding past each other. In one embodiment, the first protruding element 130 and second protruding element 160 are configured to release from one another by movement that is opposite to the direction of movement for joining the first and second portions 120, 160 and is perpendicular to a direction of movement inhibited by the transverse stabilizer. The release movement may also be perpendicular to a longitudinal axis of a beam structure formed by the beam joint, e.g. the axis of the beam formed by the joining of an end of one beam to the end of another beam.

The optional fastener is configured to inhibit separation of the first and second bevel faces 132, 172. The fastener, if used, may, in some applications, not be subjected to substantial forces, as the fastener may be configured to not receive axial forces, but simply prevent a transverse or lateral force from separating the first and second bevel faces 132, 172. The majority of the forces applied to the beam joint are translated from one beam to the other by the protruding portions and the various mating bevel faces and mating inner and outer faces. Even in cases in which a fastener is not used, the transverse stabilizer 125 and the transverse stabilizer receptor 165 maintain transverse alignment of the beam joint.

To separate the separable joint 100A, any fastener used may be removed from the fastener hole 168 and is at least removed from engagement of the first portion 120. The separable joint 100A may then be separated by laterally separating the first and second portions 120, 160, sliding the transverse stabilizer 125 out from within the transverse stabilizer receptor 165.

The beam and/or separable joint may be formed of a wide variety of materials. Examples include metals, such as, for example, aluminum, magnesium, titanium, steel and others, plastics or wood. The first and second portions 120, 160 of the beam joint may be integrally formed from, with or on to, welded to, or otherwise secured to their respective beams. A wide variety of manufacturing methods for making the beam joint of the present invention will be apparent to one of skill in the art upon review of this description and are intended to be within the scope of the invention. In one example, the first and/or second portions may be hollowed out or formed with internal strengthening members to maintain the desired structural configuration. Such configurations can reduce overall weight and materials while maintaining the desired strength of the joint.

In one application, the transverse stabilizer 125 is formed of aluminum and welded at the first inner face 127. Optionally, the transverse stabilizer 125 may be formed of a high friction material to aid in retaining the transverse stabilizer 125 within the transverse stabilizer receptor 165. Examples of such high friction material can include rubber or plastics. Surface treatments may also be used to aid in retaining the transverse stabilizer 125 within the transverse stabilizer receptor 165. In such a case, the transverse stabilizer 125 and/or the transverse stabilizer receptor 165 may be provided with a high-friction surface treatment, such as, for example, a roughened surface, to seek to maintain the transverse stabilizer 125 within the transverse stabilizer receptor 165.

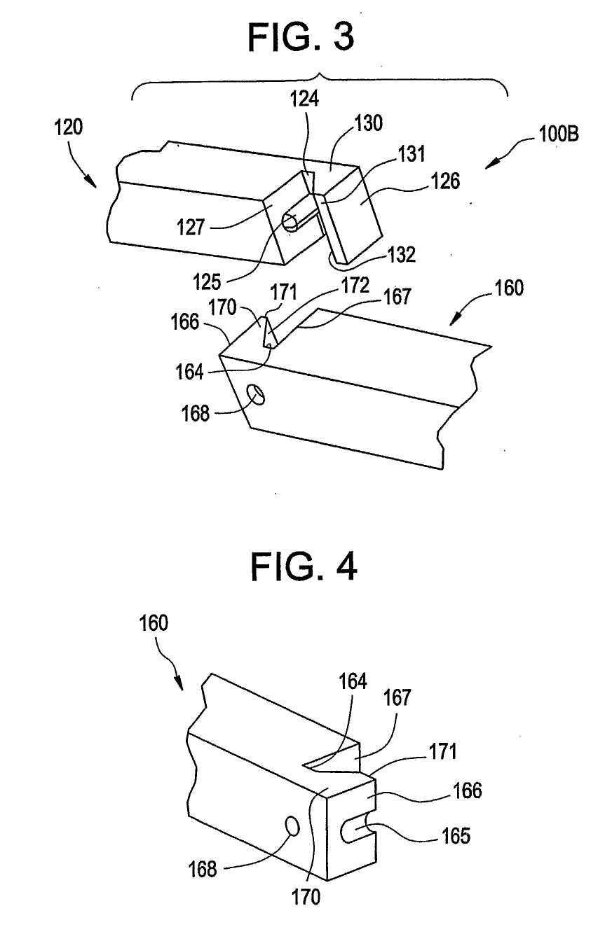

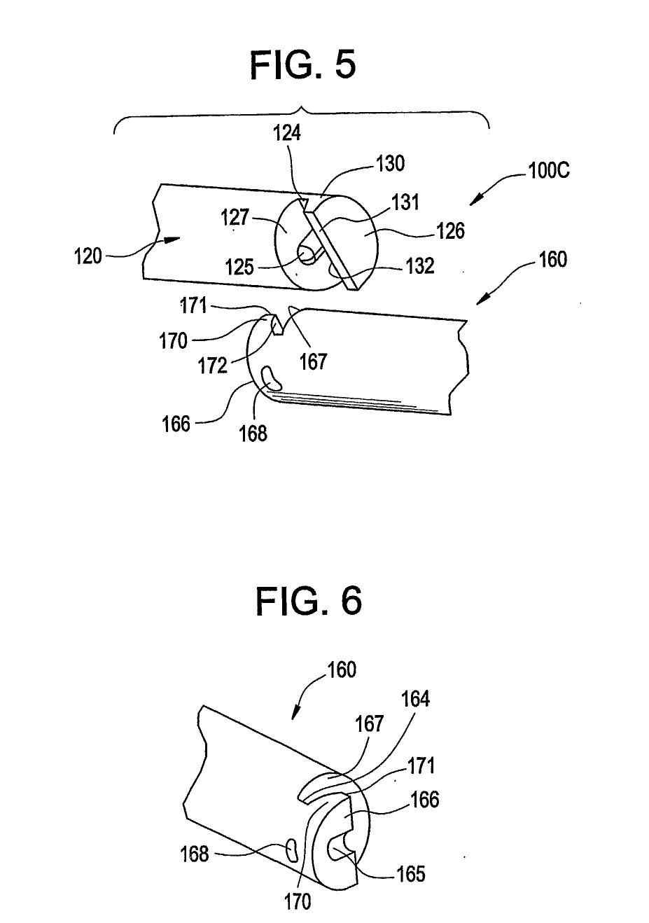

FIGS. 3 and 5 provide additional examples of separable joints 100B, 100C in tubes or beams of other cross-sections. The separable joints 100B, 100C have analogous components to those discussed above in relation to the separable joint 100A of FIG. 1. FIGS. 4 and 6 provide reverse views of the second portions 160 of the separable joints 100B, 100C of FIGS. 3 and 5, respectively.

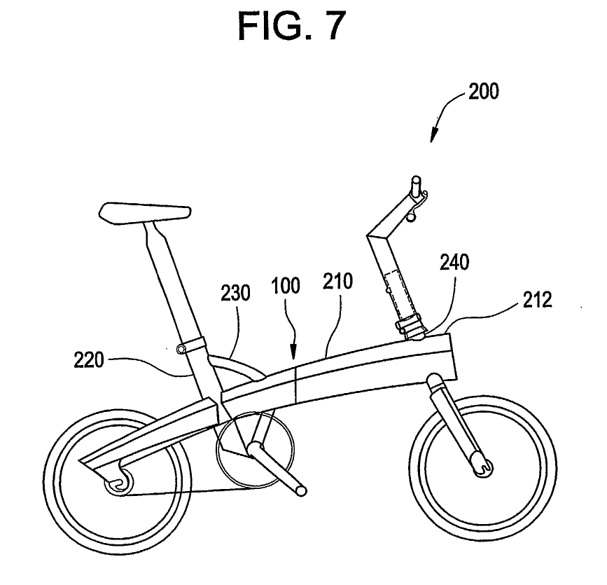

FIG. 7 illustrates a bicycle 200 including a separable joint 100 according to an example embodiment of the invention. The bicycle 200 includes a single main tube 210 having a portion 212 extending beyond a head tube 240. Optionally, the main tube 210 may form a storage compartment in the portion 212 extending beyond the head tube 240. A support tube 230 may be provided between a seat tube 220 and the main tube 210. The support tube 230 may provide additional support to the seat tube 220 and may be used as a handle to lift the bicycle 200. Optionally, a contoured hand grip (not shown) may be provided on the support tube 230 to aid in gripping the support tube 230. Optionally, the seat tube 220 may be oversized in thickness. Examples of ranges of external diameters of the seat tube 220 include at least 45 millimeters and/or a range of 45 to 65 millimeters. In one embodiment, the seat tube 220 has an external diameter of 54 millimeters.

The bicycle 200 may optionally use the separable joint 100 along the main tube 210. The separable joint 100 may be located as illustrated in FIG. 7, or may be located anywhere along the main tube 210. The separable joint 100 can allow the bicycle to be separated into two pieces to aid in transport or storage of the bicycle 200. By providing an ability to separate the bicycle 200 into two pieces, the bicycle 200 may be more easily stored in a trunk of a car, a closet or an office, than a bicycle that merely provides a folding capability.

The present invention has been described by way of example, and modifications and variations of the described embodiments will suggest themselves to skilled artisans in this field without departing from the spirit of the invention. Aspects and characteristics of the above-described embodiments may be used in combination.

The described embodiments are merely illustrative and should not be considered restrictive in any way. The scope of the invention is to be measured by the appended claims, rather than the preceding description, and all variations and equivalents that fall within the range of the claims are intended to be embraced therein.

We claim:

1. A beam joint, comprising:
a first portion having a first protruding element with a first beveled face;
a second portion having a second protruding element configured to mate with the first protruding element;
a transverse stabilizer on the first portion; and
a transverse stabilizer receptor for receiving the transverse stabilizer.

2. The beam joint of claim 1, further comprising a fastener, transversally located through the second portion to retain the first protruding element in mating with the second protruding element.

3. The beam joint of claim 2, wherein the fastener comprises a bolt and nut.

4. The beam joint of claim 1, further comprising a fastener hole that is located transversally in the first portion and the second portion.

5. The beam joint of claim 4, wherein the fastener hole in the first portion is threaded.

6. The beam joint of claim 4, further comprising a fastener, located in the fastener hole, to retain the second protruding element in a mating configuration with the first protruding element.

7. The beam joint of claim 1, wherein the second protruding element comprises a second beveled face, the first beveled face configured to mate with the second beveled face.

8. The beam joint of claim 7, wherein the first beveled face extends across a full cross-section of the first portion and the second beveled face extends across a full cross-section of the second portion.

9. The beam joint of claim 7, the first portion further comprising a first inner face and a first end face, the transverse stabilizer located at the first inner face.

10. The beam joint of claim 9, the second portion further comprising a second inner face and a second end face, the transverse stabilizer receptor located at the second inner face.

11. The beam joint of claim 10, the first inner face and the second end face configured to mate and the second inner face and the first end face configured to mate upon assembly of the beam joint.

12. The beam joint of claim 1, wherein the first portion and second portion are each located at an end of a six-sided beam.

13. The beam joint of claim 1, wherein the first portion and second portion are each located at an end of a tube having a circular cross-section.

14. The beam joint of claim 1, wherein the first portion and second portion are each located at an end of a tube having a square cross-section.

15. The beam joint of claim 1, wherein the transverse stabilizer is secured to the first portion by an aluminum weld.

16. The beam joint of claim 1, wherein the transverse stabilizer is formed of a material different from the first beveled face.

17. The beam joint of claim 1 wherein the first protruding element and second protruding element are configured to release from one another by a first movement that is perpendicular to a direction of movement inhibited by the transverse stabilizer.

18. The beam joint of claim 17, wherein the first movement is also perpendicular to a longitudinal axis of a beam structure formed by the beam joint.

19. A main beam of a bicycle, comprising:
a first portion coupled to a head tube and having a first protruding element;
a second portion coupled to a seat tube and having a second protruding element configured to mate with the first protruding element;
a transverse stabilizer located on one of the first portion and the second portion; and
a transverse stabilizer receptor for receiving the transverse stabilizer and located on another of the first portion and the second portion.

20. The main beam of claim 19, further comprising a fastener, transversally located in the first portion and the second portion to retain the first protruding element with the second protruding element.

21. The main beam of claim 19, wherein the first protruding element comprises a first beveled face and the second protruding element comprises a second beveled face, the first beveled face mating with the second beveled face; and
wherein the first beveled face extends across a full cross-section of the first portion and the second beveled face extends across a full cross-section of the second portion.
